(19) United States
(12) Patent Application Publication
(10) Pub. No.: US 2024/0196932 A1
(43) Pub. Date: Jun. 20, 2024

(54) NOVEL USE

(71) Applicant: DSM IP Assets B.V., Heerlen (NL)

(72) Inventors: Maik KINDERMANN, Kaiseraugst (CH); Ulla LETINOIS, Kaiseraugst (CH); Luis Fernando MONTEIRO TAMASSIA, Kaiseraugst (CH); René Tobias STEMMLER, Kaiseraugst (CH); Nicola WALKER, Kaiseraugst (CH)

(21) Appl. No.: 18/554,886

(22) PCT Filed: Apr. 12, 2022
(86) PCT No.: PCT/EP2022/059713

§ 371 Date: Oct. 11, 2023

(30) Foreign Application Priority Data
Apr. 15, 2021 (EP) 21168705.8

(51) Int. Cl. A23K 20/111; A23K 20/174; A23K 20/20; A23K 50/10

(52) U.S. Cl. CPC A23K 20/111; A23K 20/174; A23K 20/30; A23K 50/10

(57) ABSTRACT

The present invention relates to the field of reduction of methane emission in ruminants. Particularly. it relates to the administration of gossypol in an amount of at least 7.5 g gossypol/animal/day to a ruminant for reducing the production of methane emanating from the diges-5tive activities of said ruminant.

The present invention relates to the field of reduction of methane emission in ruminants. Particularly, it relates to the administration of gossypol in an amount of at least 7.5 g gossypol/animal/day to a ruminant for reducing the production of methane emanating from the digestive activities of said ruminant.

The present invention further relates to animal premix consisting essentially of (a) gossypol and optionally one or more of (b-1) fat soluble vitamin(s), (b-2) water soluble vitamin(s), (b-3) trace mineral(s) and (b-4) macro mineral(s) and (c) a carrier as well as the use of said premix for reducing the production of methane emanating from the digestive activities of ruminants.

The temperature of the air surrounding the earth is increasing, a process referred to as global warming. One of the main focuses to reduce this warming effect is to reduce the amount of greenhouse gases emitted into the atmosphere. Greenhouse gases are emitted from several different sources, both natural and artificial; however, the two sources with the most emphasis are the agricultural and fossil fuel industries. Within agriculture, ruminants and in particular cattle are the major contributors to the biogenic methane formation, and it has been estimated that the prevention of methane formation from ruminants would almost stabilize atmospheric methane concentrations.

Methane emission from the ruminant livestock sector—a by-product from enteric fermentation of plant biomass in the ruminant digestive system—is produced by methanogenic archaea. Various attempts have been made in the last decade to mitigate methane production from ruminant animals. Although the approaches vary, the most popular method so far are feed additives which act in the rumen fluid by reducing respectively inhibiting the methane production by methanogenic archaea.

Gossypol is a Natural Phenol of Formula (II)

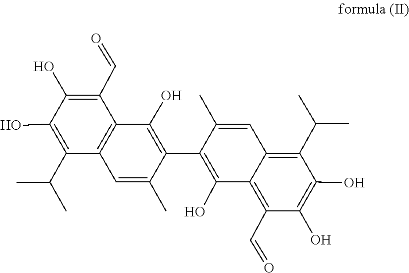 [SMILES: Cc1cc2c(C(C)C)c(O)c(O)c(C=O)c2c(O)c1-c1c(C)cc2c(C(C)C)c(O)c(O)c(C=O)c2c1O]

e.g. found in Indian tulip (genus Thespesia) plants.

Surprisingly, it has now been found, that the use of gossypol in an amount of at least 7.5 g/animal/day leads to a substantial reduction of the methane formation emanating from the digestive activities of said ruminant.

Thus, the use of gossypol has a great potential in the mitigation of climate change by significantly reducing the methane emissions emanating during the digestive activities of ruminants.

Therefore, in a first embodiment, the present invention provides the use of gossypol in an amount of at least 7.5 g gossypol/animal/day for reducing the formation of methane emanating from the digestive activities of ruminants.

In a second embodiment, the invention further provides a method for reducing the production of methane emanating from the digestive activities of ruminants, said method comprising orally administering to the animal an gossypol in an amount of at least 7.5 g gossypol/animal/day.

In a third embodiment, the present invention relates to a (ruminant) pre-mix comprising gossypol and optionally one or more of (b-1) fat soluble vitamin(s), (b-2) water soluble vitamin(s), (b-3) trace mineral(s) and (b-4) macro mineral(s) and (c) a carrier.

It is well understood, that in all embodiments of the present invention the methane reduction by the administration of gossypol is preferably at least 10%, more preferably at least 20%, most preferably at least 30% when compared to control, i.e. to ruminants not supplemented with gossypol.

Thus, the present invention also relates to the use of gossypol in amounts of at least 7.5 g/animal/ day wherein the methane production in ruminants is reduced by at least 10% compared to control.

Gossypol (CAS No: 303-45-7) exhibits an axial chirality resulting in two enantiomers. Thus, gossypol can be used in the form of each single enantiomer or as a mixture thereof. Furthermore, the term gossypol in all embodiments of the present invention can also be used as gossypol acetic acid solvate (CAS 12542-36-8). Preferably in all embodiments of the present invention gossypol is used in the form of an enantiomeric mixture, i.e. as (±) gossypol. Said gossypol is e.g. commercially available as (±)-Gossypol from cotton seeds from Sigma-Aldrich in ≥95% (HPLC). Also suitable in all embodiments of the present invention is the use of gossypol acetic acid solvate obtainable as (±)-Gossypol-acetic acid from Merck.

Preferably, in all embodiments of the present invention, the effective amount of gossypol to be administered to the ruminants is selected in the range from 7.5 to 200 g gossypol/animal/day, more preferably in the range from 25 to 150 g gossypol/animal/day, most preferably in the range from 30 to 100 g gossypol/animal/day, such as in the range from 50 to 100 g gossypol/animal/day, 75 to 100 g gossypol/animal/day or 80 to 100 g gossypol/animal/day.

Gossypol is preferably administered either as pure (distinct) chemical compound (i.e. having a purity of ≥95% (HPLC)) or via an animal premix to the ruminant, both of which are then dispersed throughout the animal feed (diet) by any of a number of ordinary mixing techniques.

Such premixes are well known to a person skilled in the art. In the main, such premixes comprise the active ingredient, i.e. gossypol, a carrier, and optionally further nutritional ingredients selected from the group consisting of such as vitamins, trace minerals and macro minerals.

A premix designates a preferably uniform mixture of one or more micro-ingredients with diluents and/or carrier. Premixes are used to facilitate uniform dispersion of micro-ingredients in a larger mix.

Particular advantageous premixes according to the present invention consist essentially of (a) gossypol and optionally of one or more of (b-1) fat soluble vitamin(s), (b-2) water soluble vitamin(s), (b-3) trace mineral(s) and (b-4) macro mineral(s) and (c) a carrier

Usual carriers employed in the art are soy grits, clays, (corn) sugars, silica, starch and similar products.

Said pre-mix may be prepared by methods known per se in the art.

Said premix are still novel. Thus, further aspects of the present invention are (ruminant) premix comprising gossypol as well as the use thereof in all uses and methods according to the present invention.

Preferred animal premixes are animal premixes comprising gossypol, a carrier, and optionally one or more ingredients selected from the group consisting of vitamins, trace minerals and macro minerals.

In one advantageous embodiment, the premixes of the present invention consist essentially of (a) gossypol, a carrier and one or more of (b-1) fat soluble vitamin(s), (b-2) water soluble vitamin(s), (b-3) trace mineral(s) and (b-4) macro mineral(s).

In one preferred embodiment, the premix is a mineral premix, a vitamin premix including vitamins and optionally minerals or a bolus.

Apart from gossypol the premix of the invention preferably contains at least one fat-soluble vitamin, and/or at least one water soluble vitamin, and/or at least one trace mineral, and/or at least one macro mineral. In other words, the premix of the invention comprises the gossypol together with at least one additional component selected from the group consisting of fat-soluble vitamins, water-soluble vitamins, trace minerals, and macro minerals.

Macro minerals may be separately added to the feed. Therefore, in a particular embodiment, the premix comprises gossypol with at least one additional component selected from the group consisting of fat-soluble vitamins, water-soluble vitamins, and trace-minerals.

The following are non-exclusive lists of examples of these components:
Examples of fat-soluble vitamins are vitamin A, vitamin D3, vitamin E, and vitamin K, e.g. vitamin K3.
Examples of water-soluble vitamins are vitamin B12, biotin and choline, vitamin B1, vitamin B2, vitamin B6, niacin, folic acid and panthothenate, e.g. Ca-D-panthothenate.

Examples of trace minerals are manganese, zinc, iron, copper, iodine, selenium, manganese, and cobalt.
Examples of macro minerals are calcium, phosphorus, potassium, magnesium and sodium.

As mentioned above a premix is an example of a feed additive. It is understood that the gossypol may be administered to the animal in different other forms. For example gossypol can also be included in a bolus that would be placed in the rumen and that would release a defined amount of gossypol continuously in the defined dosages over a specific period of time.

In all embodiments of the present invention, it is to be understood by oral administration, a simple feeding, or manual administration of a bolus.

Methane emission by ruminants can easily be measured in individual animals in metabolic chambers by methods known in the art (Grainger et al., 2007 J. Dairy Science; 90: 2755-2766). Moreover, it can also be assessed at barn level by an emerging technology using laser beam (McGinn et al., 2009, Journal of Environmental Quality; 38: 1796-1802) or Sulfur hexafluoride or just SF6 or GreenFeed system. Alternatively, methane produced by a dairy ruminant can also be assessed by measurement of fatty acid profiles in milk according to WO 2009/156453.

The present invention also relates to the use of a feed additive according to the present invention which feed additive comprises one or more additional active substance which shows similar effects with regard to methane formation in the rumen and which is selected from the group consisting of diallyl disulfide, garlic oil, allyl isothiocyanate, deoxycholic acid, chenodeoxycholic acid and derivatives thereof.

Further components that could be given together with the gossypol are for example propanediol. mononitrate (3-nitrooxypropan-1-ol), yeasts, oregano extracts, tannins and tannic acids and essential oils e.g. thymol, 3-methylphenol, limonene, vanillin, guajacol and eugenol.

It is at present contemplated that diallyl disulfide, garlic oil, allyl isothiocyanate deoxycholic acid, chenodeoxycholic acid and derivatives thereof are independently administered in dosage ranges of for example 0.01-500 mg active substance per kg feed (ppm). These compounds are either commercially available or can easily be prepared by a skilled person using processes and methods well-known in the prior art.

Propanediol mononitrate preferably is administered to the ruminants in the range from 0.05 to 5 g PDMN/animal/day, more preferably in the range from 0.1 to 4 g PDMN/animal/day, most preferably in the range from 0.25 to 3 g PDMN/animal/day. Further suitable effective amounts are selected in the range from 0.5 to 3 g PDMN/animal/day or from 1 to 3 g PDMN/animal/day.

Ruminating mammals according to the present invention include cattle, goats, sheep, giraffes, American Bison, European bison, yaks, water buffalo, deer, camels, alpacas, llamas, wildebeest, antelope, pronghorn, and Nilgai.

For all embodiments of the present invention, domestic cattle, sheep and goat are the more preferred species. For the present purposes most preferred species are domestic cattle. The term includes all races of domestic cattle, and all production kinds of cattle, in particular dairy cows and beef cattle. It is well understood, that the term dairy cows and beef cattle encompasses animals in all ages and physiological stage of life and production systems such as confined, semi-confined and grazing.

The present invention is further described by the following examples which should not be construed as limiting the scope of the invention.

### EXAMPLES

In vitro test for methane production: A modified version of the “Hohenheim Forage value Test (HFT)” was used for testing the effect of specific compounds on the rumen functions mimicked by this in-vitro system.

Principle: Feed is gadded into a syringe with a composition of rumen liquor and an appropriate mixture of buffers. The solution is incubated at 39° C. After 8 hours the quantity (and composition) of gas phase produced is measured and put into a formula for conversion.

### Reagents:

### Mass Element Solution:

6.2 g potassium dihydrogen phosphate (KH₂PO₄)
0.6 g magnesium sulfate heptahydrate (MgSO₄*7H₂O)
9 ml concentrated phosphoric acid (1 mol/l)
dissolved in distilled water to 1 l (pH about 1.6)

### Buffer Solution:

35.0 g sodium hydrogen carbonate (NaHCO₃)
4.0 g ammonium hydrogen carbonate ((NH₄)HCO₃)
dissolved in distilled water to 1 l

### Trace Element Solution:

13.2 g calcium chloride dihydrate (CaCl₂*2H₂O)
10.0 g manganese(II) chloride tetrahydrate (MnCl₂*4H₂O)
1.0 g cobalt(II) chloride hexahydrate (CoCl₂*6H₂O)
8.0 g iron(III) chloride (FeCl₃*6H₂O)
dissolved in distilled water to 100 ml

### Sodium Salt Solution:

100 mg sodium salt
dissolved in distilled water to 100 ml

### Reduction Solution:

first 3 ml sodium hydroxide (c=1 mol/l), then 427.5 mg sodium sulfide hydrate (Na₂S*H₂O) are added to 71.25 ml H₂O
solution must be prepared shortly before it is added to the medium solution

### Procedure

Sample weighing: The feed stuff (i.e. TMR (44% concentrate, 6% hay, 37% maize silage and 13% grass silage) is sieved to 1 mm and weighed exactly into 64 syringes. 4 of these syringes are the substrate controls, which display the gas production without the effect of the tested compounds. The remaining syringes contain the test substances, by groups of 4 syringes.

### Preparation of the Medium Solution:

The components are mixed in a Woulff bottle in following order:
711 ml water
0.18 ml trace element solution
355.5 ml buffer solution
355.5 ml mass element solution
The completed solution is warmed up to 39° C.followed by the addition of 1.83 ml sodium salt solution and the addition of reduction solution at 36° C. The rumen liquor is added, when the indicator turns colourless.

Extraction of the rumen liquor: 750 ml of rumen liquor are added to approximately 1,400 ml of medium solution under continued agitation and CO₂-gassing.

Filling the syringes, incubation and determining gas volumes and VFA values: The diluted rumen fluid (24 ml) is added to the glass syringe. The syringes are then incubated for 8 hours at 39° C.under gentle agitation. After 8 hours, the volume of gas produced is measured, and the percentage of methane in the gas phase is determined by gas chromatography.

### Results

The food fermented was artificial TMR (44% concentrate, 6% hay, 37% maize silage and 13% grass silage). Gossypol was obtained from Sigma-Aldrich (G8761), and used at a concentration as outlined in table 1. 3-Nitrooxy-propanol (3-NOP) was used at the concentration as outlined in table 1.

The results are presented in the following Table 1. Clear effects were obtained for the methane reduction at gossypol concentrations of at least 7.5 g gossypol/animal/day, which translates into additional performance benefit for the animal.

TABLE 1
Effect on Methane production resulting from the average of four to
eight experiments with gossypol in different concentration ranges

| | gossypol | Total methane change | |
|---|---|---|---|
| # | [μM] | [% vs. control] | in g/animal/day |
| 1 (Control) | — | — | 86.4 |
| 5 (Ref) | 100 | −69 | 17.3 |
| 6 (Ref) | 20 | −15 | 8.6 |
| 7 (Ref) | 10 | −11 | 4.3 |
| 8 (Ref) | 5 | −1 | 2 |

1. Use of gossypol in an amount of at least 7.5 g gossypol/animal/day for reducing the formation of methane emanating from the digestive activities of ruminants.

2. The use according to claim 1, wherein gossypol is administered to the ruminant in an amount selected in the range from 25 to 150 g gossypol/animal/day, preferably in the range from 30 to 100 g gossypol/animal/day, most preferably in the range from 50 to 100 g gossypol/animal/day.

3. The use according to claim 1, wherein the ruminant animal is selected from the group consisting of cattle, preferably from the group consisting of domestic cattle, most preferably from beef cattle or dairy cows.

4. The use according to claim 1, wherein the gossypol is supplemented in the form of the pure (distinct) chemical compound or in the form of an animal premix.

5. The use according to claim 4, wherein the premix comprises gossypol, a carrier, and optionally one or more ingredients selected from the group consisting of vitamins, trace minerals and macro minerals.

6. The use according to claim 5, wherein the vitamins are selected from the group consisting of fat soluble vitamins and water soluble vitamins.

7. The use according to claim 5, wherein the premix consist essentially of (a) gossypol, a carrier and one or more of (b-1) fat soluble vitamin(s), (b-2) water soluble vitamin(s), (b-3) trace mineral(s) and (b-4) macro mineral(s).

8. A method for reducing the production of methane emanating from the digestive activities of ruminants, said method comprising orally administering to the animal an gossypol in an amount of at least 7.5 g gossypol/animal/day.

9. The method according to claim 8, wherein the amount of gossypol is selected in the range from 25 to 150 g gossypol/animal/day, preferably in the range from 30 to 100 g gossypol/animal/day, most preferably in the range from 50 to 100 g gossypol/animal/day.

10. An animal premix comprising (a) gossypol, a carrier, and optionally one or more ingredients selected from the group consisting of vitamins, trace minerals and macro minerals.

11. The animal premix according to claim 10, wherein the vitamins are selected from the group consisting of fat soluble vitamins, and/s water soluble vitamins

12. The animal premix according to claim 10, wherein the premix consists essentially of gossypol, a carrier and one or more of (b-1) fat soluble vitamin(s), (b-2) water soluble vitamin(s), (b-3) trace mineral(s) and (b-4) macro mineral(s).
